(19) United States
(12) Patent Application Publication
(10) Pub. No.: US 2025/0247545 A1
(43) Pub. Date: Jul. 31, 2025

(54) Deep Video Complexity Analysis for HTTP Adaptive Streaming

(71) Applicant: Bitmovin GmbH, Klagenfurt am Wörthersee (AT)

(72) Inventors: Hadi Amirpour, Klagenfurt am Wörthersee (AT); Christian Timmerer, Klagenfurt am Wörthersee (AT)

(73) Assignee: Bitmovin GmbH, Klagenfurt am Wörthersee (AT)

(21) Appl. No.: 19/037,350

(22) Filed: Jan. 27, 2025

Related U.S. Application Data
(60) Provisional application No. 63/626,559, filed on Jan. 30, 2024.

(51) Int. Cl. H04N 19/14; G06T 9/00; H04N 19/159; H04N 19/172

(52) U.S. Cl. CPC H04N 19/14; G06T 9/002; H04N 19/159; H04N 19/172

(57) ABSTRACT

The technology described herein relates to deep video complexity analysis for video streaming. A method for supervised video complexity analysis includes receiving a series of frames of a video input at a spatial complexity predictor, which is configured to generate a spatial complexity label for a frame, the spatial complexity label being based on a DCT-based energy function, also generating a temporal complexity label for the frame by a temporal complexity predictor using a feature from a middle building block of the spatial complexity predictor for the frame, as well as another feature from the middle building block of the spatial complexity predictor for a previous frame, and predicting one or both of an encoding bitrate and an encoding time of the video input may be predicted using the spatial complexity label and the temporal complexity label. The spatial complexity predictor comprises a deep neural network (DNN), and the temporal complexity predictor comprises a subset of the building blocks of the spatial complexity predictor.

### CROSS-REFERENCE TO RELATED APPLICATIONS

This application claims priority to U.S. Patent Application No. 63/626,559 titled “Deep Video Complexity Analysis for HTTP Adaptive Streaming,” filed Jan. 30, 2024, the contents of which are hereby incorporated by reference in their entirety.

### BACKGROUND OF INVENTION

Given the growth of video streaming and its applications, video optimization is important for content providers looking to enhance their services. Enhancing the quality of videos typically requires adjustment of different encoding parameters, such as resolution and framerate. To avoid brute force approaches for predicting optimal encoding parameters, video complexity features are typically extracted and utilized. Conventional methods to predict optimal encoding parameters include unsupervised feature extraction methods, such as Spatial Information (SI) and Temporal Information (TI) to represent the spatial and temporal complexity of video sequences. Unsupervised features, however, cannot accurately predict video encoding parameters.

Beyond video coding format, there are multiple encoding parameters that need to be optimized for efficient video delivery, considering the complexity of the video content at the block-level, frame-level, and sequence level. Certain applications require extraction of block-based features. Some conventional methods leverage the complexity of Coding Tree Units (CTU) to predict the optimal tile partitioning in HEVC, initially encoding the first frame and subsequently, by analyzing the workload of CTUs, predicting the tile partitioning for the following frame. However, this method necessitates encoding the frames to predict upcoming frames. Several approaches incorporate the complexity of CTUs to predict the Coding Unit (CU) partitioning and expedite the CTU encoding process by bypassing the Rate-Distortion Optimization (RDO) process. For example, spatial complexity of CUs is sometimes employed to predict the CU partitioning. In another example, there is a constraint imposed on the maximum number of CUs subjected to the RDO process. This constraint aims to avoid processing CUs at large tree depths, which is observed to incur high complexity costs with minimal encoding gains.

At the frame level and subsequently at the sequence level, which can be optimized by pooling frame-level features, spatial and temporal complexity features are crucial in many known applications. These include rate control mode, the set of bitrates and their corresponding resolution and frame rates, group of pictures (GOP) structure, and the selection of coding tools such as presets. For example, per-title encoding approaches have been proposed to optimize the selection of bitrate ladder for each video title. This is achieved by producing trial encodings of each video at multiple resolutions for each bitrate and then selecting the optimal resolution/bitrate to achieve the highest quality. In the PSTR approach proposed by Amirpour et al., the optimal framerate is also determined for each bitrate, in addition to the optimal resolution. This is achieved by encoding each bitrate at a set of resolutions and framerates and calculating and finding the optimal framerate and resolution for each video title. Two-pass encoding approaches are also commonly used to improve encoding efficiency. In two-pass encoding, the video is first encoded in a first pass that analyzes the video to determine the most efficient encoding settings for the second pass, which produces the final encoded video. The first pass generates a log file that is then used in the second pass to produce the final encoded video. The first pass can take longer than a single-pass approach, but it results in higher quality and more efficient encoding. These brute force approaches that select optimal encoding parameters after encoding and computing video quality can result in high costs. They are often unfeasible for live video streaming applications. However, avoiding these optimizations can lead to low-quality video streams. To strike a balance between these two extremes, it is necessary to develop features that can represent the complexity of video sequences and predict optimal encoding parameters without the need to encode the video.

In HAS, encoding at scale poses challenges for content providers, who must optimize various parameters to efficiently deliver video streams. In order to achieve fast video encoding, streaming service providers often utilize large cloud computing services and employ opportunistic load balancing (OLB) algorithms to ensure that processing cores are efficiently utilized. However, this approach can lead to load imbalance or diminished video quality for viewers if simple scheduling algorithms assign multiple and complex encoding tasks to low-power computing units or if high-power resources are inefficiently utilized for videos with low encoding time requirements. Therefore, it is necessary to develop more sophisticated scheduling algorithms that can optimize processing unit usage and minimize video encoding time, resulting in significant cost savings. To mitigate these risks, an approach has been proposed that takes into account both the encoding time and the price of instances when optimizing massive encodings over multiple instances. This approach offers cost savings while ensuring that encoding tasks are distributed evenly across computing units. Accurately predicting the encoding time of video segments is crucial for such algorithms to work effectively. Video complexity features are therefore in high demand as they play a vital role in predicting the encoding time accurately. Video quality evaluation is yet another critical aspect of video processing that demands video complexity analysis.

Therefore, deep video complexity analysis for video streaming is desirable.

### BRIEF SUMMARY

The present disclosure provides for techniques relating to deep video complexity analysis for video streaming. A method for deep video complexity analysis may include receiving, by a spatial complexity predictor, a series of frames of a video input; generating, by the spatial complexity predictor, a spatial complexity label for a frame of the series of frames, the spatial complexity label being based on a DCT-based energy function; generating, by a temporal complexity predictor, a temporal complexity label for the frame by encoding the frame with respect to a previous frame, the temporal complexity label being based on a comparison of DCT-based energy functions using Sum of Absolute Differences (SAD); and predicting one or both of an encoding bitrate and an encoding time of the video input may be predicted using the spatial complexity label and the temporal complexity label, wherein the spatial complexity predictor comprises a deep neural network (DNN), and the temporal complexity predictor comprises a subset of the building blocks of the spatial complexity predictor. In some examples, generating the spatial complexity label comprises compressing the frame in an all-intra encoding mode. In some examples, the DCT-based energy function maps the texture from a multi-dimensional frequency space into a one-dimensional energy space. In some examples, generating the spatial complexity label comprises encoding the frame as an I-frame. In some examples, the previous frame has been encoded as an I-frame. In some examples, the temporal complexity label is further based on a concatenation of a first feature extracted from a middle building block of the spatial complexity predictor for the frame and a second feature extracted from the middle building block of the spatial complexity predictor for the previous frame. In some examples, the temporal complexity label is based on an SAD of weighted DCT values with respect to the previous frame. In some examples, generating the temporal complexity label comprises encoding the frame as a P-frame. In some examples, generating the temporal complexity label comprises encoding the frame as a B-frame.

A system for deep video complexity analysis may include a memory comprising non-transitory computer-readable storage medium configured to store video data and neural networks; one or more processors configured to execute instructions stored on the non-transitory computer-readable storage medium to implement: a plurality of spatial complexity predictors, each spatial complexity predictor comprising a deep neural network (DNN) having a first convolutional layer, a last convolutional layer, and a plurality of middle building blocks in between the first convolutional layer and the last convolutional layer, a spatial complexity predictor being configured to generate a spatial complexity value for a given frame; and a plurality of temporal complexity predictors, each temporal complexity predictor comprising a lightweight DNN having a subset of the plurality of middle building blocks and the last convolutional layer, a temporal complexity predictor being configured to generate a temporal complexity value for the given frame using a first extracted feature from one of the plurality of middle building blocks from a first spatial complexity predictor for the given frame and a second extracted feature from the same one of the plurality of building blocks from a second spatial complexity predictor for a frame previous to the given frame, the subset of the plurality of middle building blocks comprising the middle building blocks subsequent to the one of the plurality of middle building blocks. In some examples, each spatial complexity predictor comprises one, or a combination, of a convolutional layer, a fully connected layer, a rectified linear units (ReLU), a building block with residual connections, a batch normalization, a global average pooling layer, an MBConv layer, a depthwise convolutional layer, a Squeeze and Excitation block, and a dropout layer. In some examples, the first convolutional layer, the last convolutional layer, and the plurality of middle building blocks vary in one, or a combination, of a channel size, striding, and a convolutional filter size. In some examples, the one or more processors is further configured to execute instructions stored on the non-transitory computer-readable storage medium to concatenate the first feature extracted and the second extracted feature for inputting to each temporal complexity predictor. In some examples, the one or more processors is further configured to execute instructions stored on the non-transitory computer-readable storage medium to predict one or both of an encoding bitrate and an encoding time of a video input comprising the given frame and the frame previous to the given frame.

### BRIEF DESCRIPTION OF THE DRAWINGS

FIGS. 1A-1E are an exemplary frame of a video input, including variations representing features of said frame, in accordance with one or more embodiments.

FIG. 2 is a simplified block diagram illustrating an exemplary supervised deep video complexity analysis architecture, in accordance with one or more embodiments.

FIG. 3 is a simplified block diagram illustrating an exemplary supervised deep video complexity analysis process, in accordance with one or more embodiments.

FIGS. 4A-4B are flow diagrams illustrating exemplary methods for deep video complexity analysis, in accordance with one or more embodiments.

FIG. 5A is a simplified block diagram of an exemplary computing system configured to implement the encoding system and processes shown in FIGS. 2-4B, in accordance with one or more embodiments.

FIG. 5B is a simplified block diagram of an exemplary distributed computing system implemented by a plurality of the computing devices in FIG. 5A, in accordance with one or more embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods, a non-transitory computer-readable storage medium storing executable code, and systems for perceptually aware online per-title encoding.

In this invention, a novel supervised feature extraction method extracts spatial and temporal complexity of video sequences using deep neural networks. The encoding bits required to encode each frame intra-mode and inter-mode are used as labels for spatial and temporal complexity. The similarity of features used to predict the spatial complexity of the current frame and its previous frame are leveraged to rapidly predict temporal complexity. Temporal complexity may depend not only on the differences between two consecutive frames, but also on their spatial complexity. The supervised feature extraction methods described herein demonstrate significant improvement over unsupervised methods, particularly for temporal complexity. The supervised feature extraction methods described herein are effective for predicting the encoding bitrate and encoding time of video sequences.

Video quality evaluation is a critical aspect of video processing that demands video complexity features. One common challenge in evaluating video quality is conducting subjective tests, which can be expensive and time-consuming. To address this, clustering techniques can be used to group similar videos together and select representative samples from each cluster for evaluation. Accurately identifying and selecting these representative samples can greatly improve the efficiency of video quality evaluation. Video complexity features are also widely used in the development of video quality metrics. These features provide valuable information about the characteristics of a video that affect its quality, such as spatial and temporal complexity, texture, and motion. By incorporating these features into quality metrics, the metrics can more accurately reflect the perceptual quality of a video.

The feature extraction methods described herein focus on frame-level spatial and temporal features, which can be extrapolated to video sequences. The methods comprise a DeepVCA, a supervised video complexity analysis framework that uses deep neural networks to learn features from videos. In some examples, DeepVCA comprises a supervised frame-level deep neural network-based (DNN) method for extracting spatial and temporal complexity features. For spatial complexity, DNNs may be used to predict the spatial complexity of each frame independently by utilizing the number of bits required to encode each frame as an intra-frame (I-frame). For temporal complexity, the similarity among features extracted for predicting spatial complexity of a current frame and its previous frame may be leveraged to efficiently estimate temporal complexity. In some examples, this may be defined as a number of bits required to encode a frame in inter-mode (P-frame).

Unlike unsupervised methods, the methods described herein may use labeled data for training and can provide more accurate and meaningful representations of video complexity. As described herein, supervised video complexity analysis methods (i.e., DeepVCA) may be used for one or both of encoding bitrate prediction and encoding time prediction across a range of encoding modes.

### Video Complexity Features

Feature extraction is an essential process in computer vision that involves identifying relevant information or patterns from signals for further analysis, clustering, and prediction. In video processing, feature extraction is particularly critical in video compression, where the spatial and temporal complexity of video data can significantly impact compression efficiency. Spatial complexity in a video refers to the amount of information or detail in a single frame of the video. It is a measure of the level of detail and complexity of a frame independent of other frames, as well as the degree of variation in pixel values within the frame. On the other hand, temporal complexity refers to the variation or difference between two consecutive frames in a video sequence. SI (Spatial Information) and TI (Temporal Information) are two common types of features used to represent the spatial and temporal complexity of video sequences. These features play an important role in determining the level of impairment suffered when the video is transmitted over a fixed-rate digital transmission service channel.

In some examples, SI may be obtained through the application of a Sobel filter to each video frame (Fₜ) at a given time (t). The Sobel-filtered frame may then be processed to determine the standard deviation over the pixels (stdspace). This method can be mathematically expressed as:

$$SI = stdspace ( Sobel ( {F}_{t} ) ) \qquad ( 1 )$$

This process may repeated for all frames in the video sequence, resulting in a time series of SI for a scene. A maximum value in the time series (maxtime) may be selected to represent the spatial information content of the scene. The computation of TI involves the motion difference feature Mₜ(i,j), which is the difference between the pixel values of the luminance plane at the same spatial location but at successive frames or times. The measure of temporal information TI is obtained by computing the standard deviation over space (stdspace) of Mₜ(i,j) over all i and j. In mathematical terms, TI may be expressed as:

$$TI = stdspace [ {F}_{t} ( i , j ) - {F}_{t - 1} ( i , j ) ] \qquad ( 2 )$$

$${M}_{t} ( i , j )$$

where Fₜ (i,j) represents the pixel at the i^{th} row and j^{th} column of the t^{th} frame in time. The measure of temporal information in a scene may be obtained by computing the maximum over time of all TI values. Higher values of TI indicate more motion in adjacent frames.

A Video Complexity Analyzer (VCA) may extract spatial and temporal complexity features based on a Discrete Cosine Transform (DCT)-based energy function. For example, a DCT-based energy function may be defined by the following equation:

$${E}_{DCT} ( c , f ) = {\sum }_{i = 1}^{w} {\sum }_{j = 1}^{h} {e}^{{( \frac{i \cdot j}{w \cdot h} )}^{2} - 1} \vert DCT ( i - 1 , j - 1 ) \vert \qquad ( 3 )$$

where E_{DCT}(c, f) represents the energy of the block c in frame f, w and h are the width and height of the block, and DCT_{c,f}(i,j) is the (i,j)^{th} DCT component when i+j>2, resulting in its inclusion, and otherwise being 0. This energy function maps the texture from a multi-dimensional frequency space into a one-dimensional energy space. It assigns exponentially higher costs to higher DCT frequencies, as higher frequencies are expected to be caused by a mixture of objects. The DC value (e.g., average or mean value of input data, first coefficient in the transformed data) may be treated separately as it is color-dependent and does not affect the texture.

In VCA, the spatial complexity of each frame, denoted as E, is computed by averaging the energy function over all blocks in a frame, as shown below:

$$E = \frac{1}{C} {\sum }_{c = 1}^{C} \frac{1}{{w}^{2}} {E}_{DCT} ( c , f ) \qquad ( 4 )$$

Here, C denotes the total number of blocks per frame, and w² represents the size of each block. For the temporal complexity, the E_{DCT} of each block in each frame is compared to the E_{DCT} of the corresponding block in the previous frame using the Sum of Absolute Differences (SAD) measure. The average SAD for each frame (t) is then computed to obtain the temporal complexity feature (h), which may be expressed as follows:

$$h = \frac{1}{C} {\sum }_{c = 1}^{C - 1} \frac{1}{{w}^{2}} SAD ( {E}_{DCT} ( c , f ) , {E}_{DCT} ( c , f - 1 ) ) \qquad ( 5 )$$

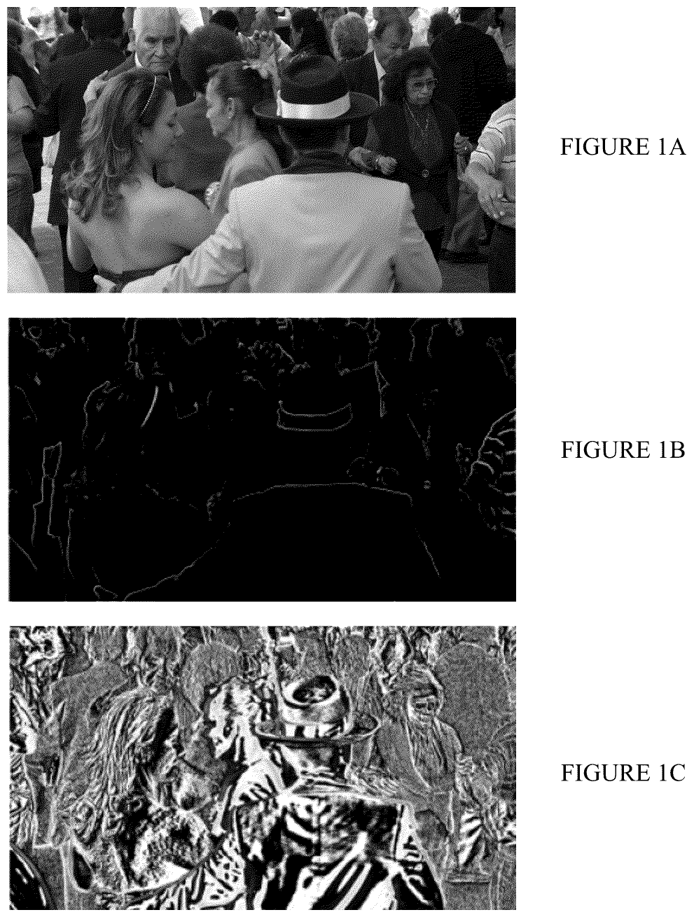

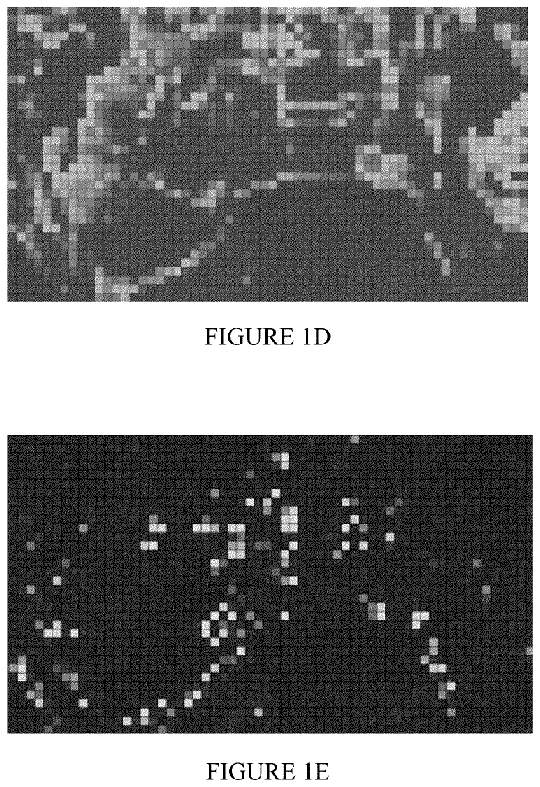

FIGS. 1A-1E are an exemplary frame of a video input, including variations representing features of said frame, in accordance with one or more embodiments. In particular, FIGS. 1A-1C comprises an example frame showing (A) the original frame, (B) the frame with a Sobel filter, and (C) the frame with the motion difference feature Mₜ(i,j) having been applied. Although the frame in FIG. 1A is shown in black and white, those of ordinary skill in the art would understand that the methods described herein also may be used with frames from color images and videos. FIGS. 1D-1E provide examples of a heatmap of E_{DCT} of the frame in FIG. 1A and a heatmap of SAD of E_{DCT} of the frame in FIG. 1A, respectively. Although the frames in FIGS. 1A-1E are shown in black and white, it would be obvious to one of ordinary skill in the art that the frame in FIG. 1A may comprise various colors (i.e., the frame may be from a video input that is in color) and any of modified frames in FIGS. 1B-1E also may be represented with one or more colors. For example, the heatmaps may comprise variations or gradients of red(s), orange(s), yellow(s), grey(s), black(s), white(s) to indicate varying degrees, values, or value ranges.

In other examples, an enhanced VCA may comprise a modified definition of temporal complexity for frame f to include the SAD of weighted DCT values. In an example, a modified temporal complexity TC may be represented as:

$$T C = \frac{1}{C} {\sum }_{c = 1}^{C} \frac{1}{{w}^{2}} {tc}_{c , f} \qquad ( 6 )$$

$$where$$

$${tc}_{c , f} = {\sum }_{i = 1}^{w} {\sum }_{j = 1}^{h} {e}^{{( \frac{i \cdot j}{w \cdot h} )}^{2} - 1} \vert {DCT}_{c , f} ( i - 1 , j - 1 ) - {DCT}_{c , f - 1} ( i - 1 , j - 1 ) \vert \qquad ( 7 )$$

In some examples, the SC of an enhanced VCA may be set to be the same as E. In some examples, the temporal complexity may be defined with respect to more previous frames in addition to with respect to the previous frame (e.g., two or more previous frames).

### Deep Video Complexity Analysis

Although unsupervised feature extraction methods are frequently used for representing the spatial and temporal complexity of videos, DeepVCA, which utilizes deep neural networks for supervised feature extraction in both spatial and temporal domains.

### Frame Complexity

In video compression, frames may be encoded using either intra- or inter-frame compression. In intra-frame encoding, also known as I-frame encoding, each frame is compressed independently from other frames, and the encoded data contains all the information needed to reconstruct the frame. In contrast to I-frame encoding, in inter-frame encoding, also known as P-frame and B-frame encoding, only the changes between frames are encoded. P-frames are encoded based on a reference frame, typically the previous I-frame or P-frame, while B-frames are encoded based on both the previous and the next reference frames.

For DeepVCA, in some examples, the Spatial Complexity (SC) of a frame comprises the number of bits required to encode the frame. Since I-frames are encoded independently, the number of bits required to encode each frame is solely determined by its spatial complexity. An all-intra encoding mode to compress the video dataset may be used to generate a target label for spatial complexity (i.e., a spatial complexity label) comprising the encoding bits of the frame.

In some examples, the Temporal Complexity (TC) of a frame comprises the number of bits required when each frame is encoded as a P-frame with respect to its previous frame that has been encoded as an I-frame using the same quantization parameter (QP). In some examples, each frame may be intra-coded in SC (e.g., by a spatial complexity predictor, as described herein) and then inter-coded in TC with respect to a previously intra-coded frame. In some examples, this may be viewed as odd frames being intra-coded and even frames being inter-coded with respect to their previous intra-coded frame, the resulting encoding bits for even frames being used as a target label for temporal complexity (i.e., a temporal complexity label). In other examples, an I-frame to B-frame structure (i.e., encoding a B-frame with respect to its previous frame that has been encoded as an I-frame), P-frame to P-frame structure, or other complementary encoding structure may be used.

### DeepVCA Architecture

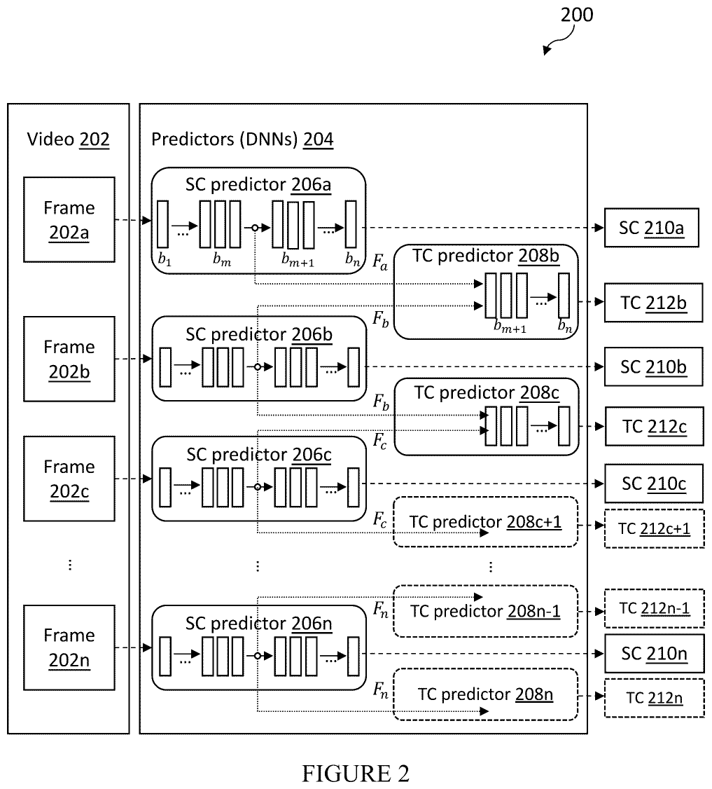

FIG. 2 is a simplified block diagram illustrating an exemplary supervised deep video complexity analysis (i.e., DeepVCA) architecture, in accordance with one or more embodiments. As shown in diagram 200, frames 202a-202n of video 202 may be input to predictors 204 to generate spatial complexity labels 210a-210n and temporal complexity labels 212b-212n. In some examples, frames 202a-202n may comprise a sequence of frames of video 202. In some examples, SC predictors 206a-206n each may comprise a deep neural network configured to receive a frame (e.g., one of frames 202a-202n) and to output a corresponding spatial complexity value/label (e.g., SCs 201a-210n).

Only the frame itself is needed to determine its spatial complexity, therefore SC predictor 206a can predict the spatial complexity value 210a using frame 202a alone, SC predictor 206b can predict the spatial complexity value 210b using frame 202b alone, SC predictor 206c can predict the spatial complexity value 210c using frame 202c alone, and so on. As the complexity of the DNN used is also an important factor, especially for live applications, an SC predictor may need only use the Y channel of each input frame in some examples. Also, in some examples, lightweight DNNs may be sufficient (e.g., AlexNet, VGG11, ResNet-18, MobilNetV2, and EfficientNet-b0). In some examples, a DNN architecture for an SC predictor may comprise eight layers, including five convolutional layers and three fully connected layers. In some examples, the DNN architecture may further use rectified linear units (ReLU) as an activation function, which allows for faster training and improved performance. In other examples, a DNN architecture for an SC predictor may comprise eleven layers, including eight convolutional layers and three fully connected layers. Such DNNs may be simple, uniform, and effective in image classification tasks. In some examples, a DNN architecture for an SC predictor may comprise eight building blocks with residual connections, batch normalization, and ReLU activation functions. In some examples, the DNN architecture also may include a global average pooling layer and a fully connected layer. Such DNNs may reduce the problem of vanishing gradients. In still other examples, a DNN architecture may comprise seventeen (17) consecutive building blocks, along with a regular 1×1 convolution, a global average pooling layer, and a fully connected layer. Such DNNs may be optimized for mobile and embedded vision applications. In yet other examples, a DNN architecture may comprise seven building blocks that vary in channel size, striding, and convolutional filter size, among other factors, using a mobile inverted bottleneck (i.e., MBConv) as its primary building block. An MBConv may comprise two convolutional layers, a depthwise convolutional layer, a Squeeze and Excitation block, and a dropout layer. Such DNNs may be configured to balance model size, computational resources, and accuracy.

To predict the temporal complexity of a frame (e.g., frames 202b-202n), TC predictors 208b-208n may use features (e.g., Fₐ, F_{b}, F_{c}, Fₙ) extracted from a middle part of an SC predictor previously used to predict a spatial complexity value for a previous frame. For example, feature Fₐ extracted from the middle part of SC predictor 206a that is used to predict SC 210a also may be used by TC predictor 208b, along with feature F_{b} extracted from the middle part of SC predictor 206b, to predict TC 212b. Such middle features from SC predictors 206a-206n may be fed into TC predictors 208b-208n (as well as any TC predictors for a previous frame or a subsequent frame, e.g., TC predictor 208c+1 and TC predictor 208n-1), which are configured to output temporal complexity values TCs 212b-212n. In some examples, TC predictors 208a-208n may be modified versions of SC predictors 206a-206n, using a part of SC predictors 206a-206n as part of their architecture. When one of TC predictors 208b-208n extracts features from a building block (e.g., bₘ) of one of SC predictors 206a-206n, the TC predictor architecture may include a partial part of the SC predictor that starts from said building block (e.g., bₘ₊₁ through bₙ).

To predict the temporal complexity, features that have been extracted from each frame (e.g., a current frame and a previous frame) while predicting that frame's spatial complexity may be used, instead of the frames themselves, as inputs to a TC predictor network. In some examples, the features extracted from a middle layer of a DNN that predicts the spatial complexity of each frame may be concatenated with the features extracted from a middle layer of the same DNN that predicts the spatial complexity of the previous frame.

### DeepVCA Methods

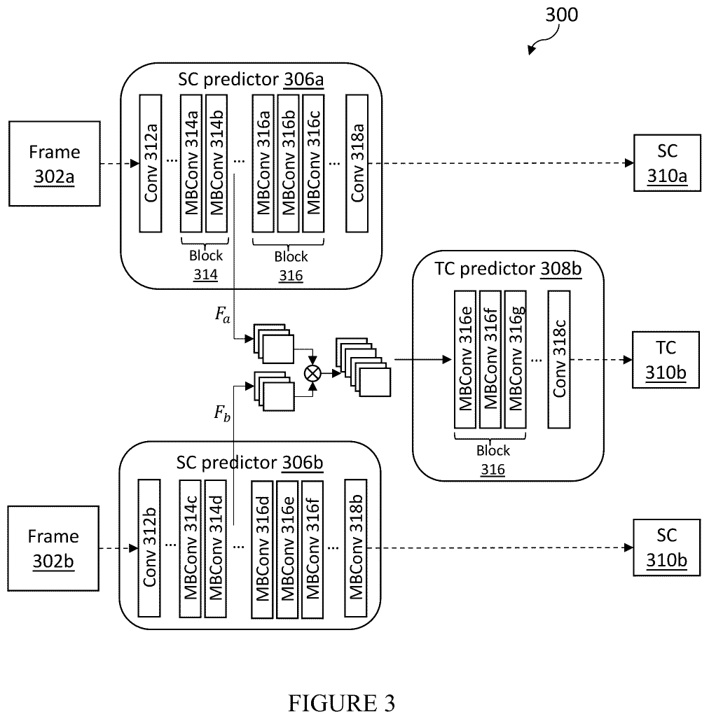

FIG. 3 is a simplified block diagram illustrating an exemplary supervised deep video complexity analysis (i.e., DeepVCA) process, in accordance with one or more embodiments. Diagram 300 shows frames 302a-302b, SC predictors 306a-306b, and TC predictor 308b. SC predictors 306a-306b may each comprise a first convolutional layer 312a-312b and last convolutional layers 318a-318b, as well as a plurality of MBConv blocks between. In an example, features Fₐ and F_{b} may be generated from MBConv block 314 (i.e., a middle building block) in SC predictor 306a (i.e., MBConv layers 314a-314b) and 306b (i.e., MBConv layers 314c-314d), respectively, along with other features (e.g., by MBConv block 316, etc.), in the process of generating spatial complexity values SC 310a-310b. Features Fₐ and F_{b} may be extracted and concatenated to be input into TC predictor 308b to generate temporal complexity value TC 310b. In some examples, TC predictor 308b may comprise a lightweight DNN model having the building blocks of the same DNN as in SC predictors 306a and 306b after where the features Fₐ and F_{b} were extracted (e.g., starting with MBConv block 316 and on). This approach has two advantages: (1) it leverages the similarity among the rich features extracted to predict the spatial complexity of both frames to aid in predicting the temporal complexity, and (2) it significantly reduces the feature extraction process required for predicting temporal complexity. In some examples, there may be several middle building blocks in an SC predictor to choose from for extracting a feature to contribute to a TC predictor input. Using a feature from a later middle block of an SC predictor results in a smaller fraction of the DNN needed for the TC predictor. For example, where SC predictors 306a-306b comprise seven building blocks, block 314 may comprise a second, third, fourth, fifth, or sixth block. In another example, SC predictors 306a-306b may comprise eighteen building blocks, and block 314 may comprise any block from the second to the seventeenth block (e.g., a range from a fourth block to an eleventh or twelfth block may be chosen to balance efficiency and accuracy).

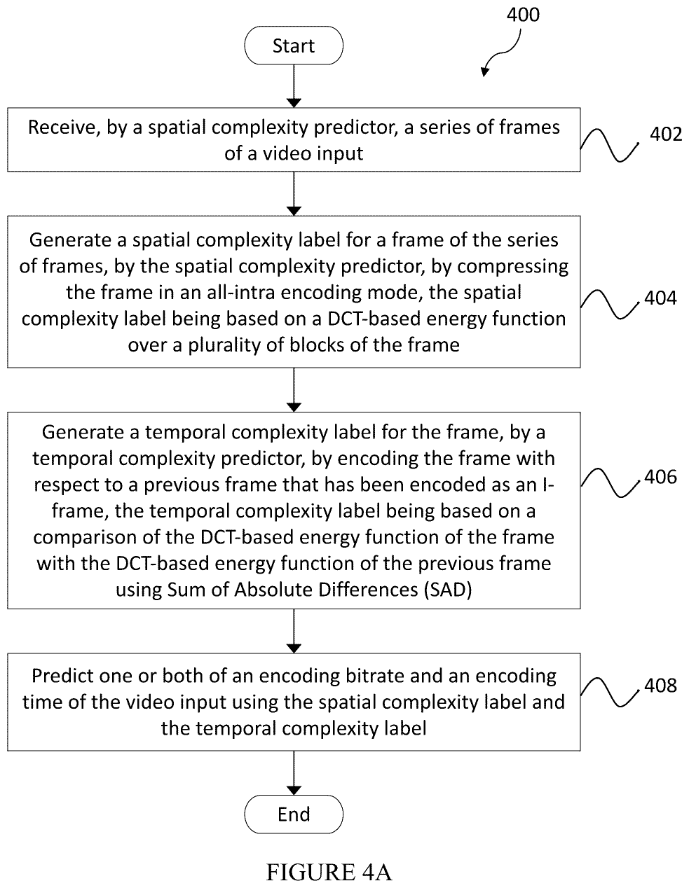

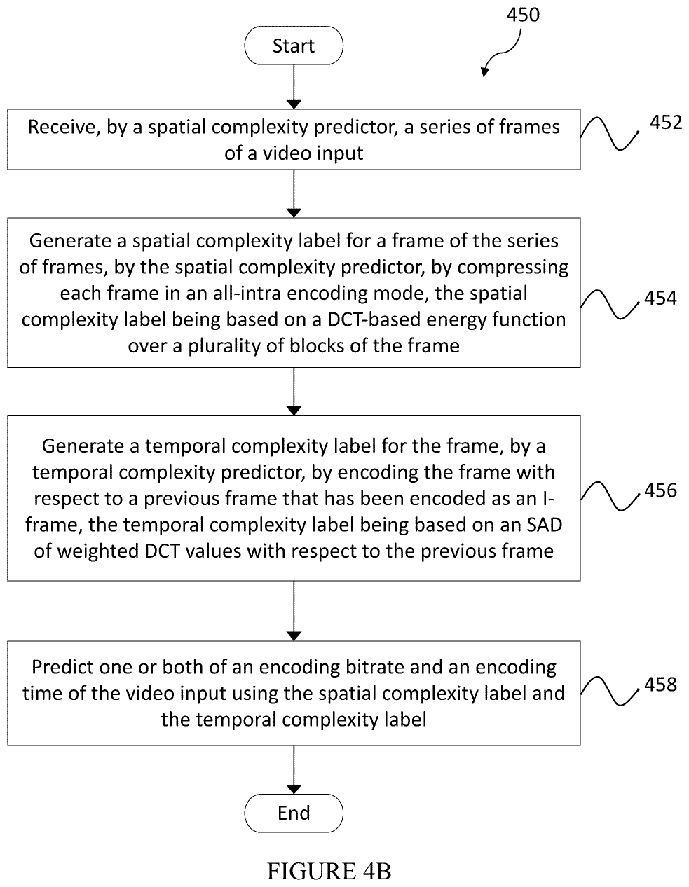

FIGS. 4A-4B are flow diagrams illustrating exemplary methods for deep video complexity analysis, in accordance with one or more embodiments. Method 400 may begin with receiving, by a spatial complexity predictor, a series of frames of a video input at step 402. A spatial complexity label for a frame of the series of frames may be generated by the spatial complexity predictor by compressing the frame in an all-intra encoding mode at step 404, the spatial complexity label being based on a DCT-based energy function over a plurality of blocks of the frame. In some examples, the DCT-based energy function maps the texture from a multi-dimensional frequency space into a one-dimensional energy space. In some examples, the spatial complexity predictor may comprise a plurality of building blocks comprising one, or a combination, of convolutional layers (e.g., 1×1, 3×3, etc.), fully connected layers, rectified linear units (ReLU) as an activation function, building blocks with residual connections, batch normalization, a global average pooling layer, MBConv layers (e.g., 1×1, 3×3, 5×5 etc.), a depthwise convolutional layer, a Squeeze and Excitation block, a dropout layer, including layers that vary in channel size, striding, and convolutional filter size, among other factors. In some examples, the spatial complexity predictor may be configured to encode the frame as an I-frame. A temporal complexity label for the frame may be generated by a temporal complexity predictor at step 406, by encoding the frame with respect to a previous frame that has been encoded as an I-frame (e.g., by the spatial complexity predictor). In some examples, the temporal complexity label may be based on a comparison of the DCT-based energy function of the frame with the DCT-based energy function of the previous frame using Sum of Absolute Differences (SAD). In some examples, the temporal complexity label may be based on a concatenation of a first feature extracted from a middle building block of the spatial complexity predictor for the frame and a second feature extracted from the middle building block of the spatial complexity predictor for the previous frame. In some examples, the temporal complexity predictor may comprise a subset of the plurality of building blocks in the spatial complexity predictor. In some examples, the subset of the plurality of building blocks comprises the building blocks from the spatial complexity predictor that are subsequent to the middle building block. In some examples, the temporal complexity label may result from encoding the frame as a P-frame or a B-frame. One or both of an encoding bitrate and an encoding time of the video input may be predicted using the spatial complexity label and the temporal complexity label at step 408.

Method 450 may begin with receiving, by a spatial complexity predictor, a series of frames of a video input at step 452. A spatial complexity label for a frame of the series of frames may be generated by the spatial complexity predictor by compressing the frame in an all-intra encoding mode at step 454, the spatial complexity label being based on a DCT-based energy function over a plurality of blocks of the frame. In some examples, the DCT-based energy function maps the texture from a multi-dimensional frequency space into a one-dimensional energy space. In some examples, the spatial complexity predictor may comprise a plurality of blocks comprising one, or a combination, of convolutional layers (e.g., 1×1, 3×3, etc.), fully connected layers, rectified linear units (ReLU) as an activation function, building blocks with residual connections, batch normalization, a global average pooling layer, MBConv layers (e.g., 1×1, 3×3, 5×5 etc.), a depthwise convolutional layer, a Squeeze and Excitation block, a dropout layer, including layers that vary in channel size, striding, and convolutional filter size, among other factors. In some examples, the spatial complexity predictor may be configured to encode the frame as an I-frame. A temporal complexity label for the frame may be generated by a temporal complexity predictor at step 456, by encoding the frame with respect to a previous frame that has been encoded as an I-frame (e.g., by the spatial complexity predictor). In some examples, the temporal complexity label may be based on an SAD of weighted DCT values with respect to the previous frame. In other examples, the temporal complexity label may be determined with respect to two or more previous frames. In some examples, the temporal complexity label may be based on a concatenation of a first feature extracted from a middle building block of the spatial complexity predictor for the frame and a second feature extracted from the middle building block of the spatial complexity predictor for the previous frame. In some examples, the temporal complexity predictor may comprise a subset of the plurality of blocks in the spatial complexity predictor. In some examples, the subset of the plurality of blocks comprises the building blocks from the spatial complexity predictor that are subsequent to the middle building block. In some examples, the temporal complexity label may result from encoding the frame as a P-frame or a B-frame. One or both of an encoding bitrate and an encoding time of the video input may be predicted using the spatial complexity label and the temporal complexity label at step 458.

Video complexity metrics can play a significant role in improving the Quality of Service (QOS) in HAS applications. Accurately predicting encoding bitrate can improve rate-control algorithms, while accurately predicting encoding time can help to optimize resource utilization when encoding multiple videos simultaneously. In some examples, the number of bits required to encode each frame in intra-mode at a QP of 22 may be used as a label for spatial complexity. In some examples, EfficientNet-b0 may perform well as a backbone, resulting in a Pearson correlation coefficient (PCC) of 0.97 with actual complexity, which is significantly higher than conventional methods. In some examples, a trained model may be insensitive to encoding parameters and codecs, making it a versatile tool for predicting video complexity in various contexts. In other examples, the methods described herein can achieve a PCC of 0.92 and 0.82 for predicting encoding bitrate and encoding time, respectively.

### Computing Systems

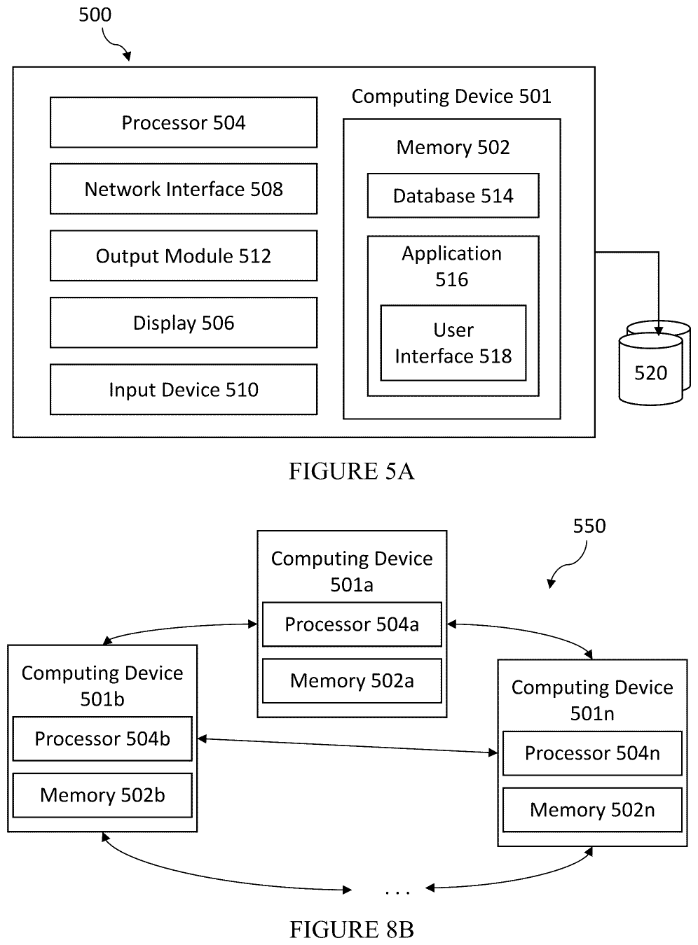

FIG. 5A is a simplified block diagram of an exemplary computing system configured to implement the encoding system and processes shown in FIGS. 2-4B, in accordance with one or more embodiments. In one embodiment, computing system 500 may include computing device 501 and storage system 520. Storage system 520 may comprise a plurality of repositories and/or other forms of data storage, and it also may be in communication with computing device 501. In another embodiment, storage system 520, which may comprise a plurality of repositories, may be housed in one or more of computing device 501. In some examples, storage system 520 may store networks, video data (e.g., video input, frames, spatial complexity values, temporal complexity values), bitrate ladders, codecs, metadata, instructions, programs, and other various types of information as described herein. This information may be retrieved or otherwise accessed by one or more computing devices, such as computing device 501, in order to perform some or all of the features described herein. Storage system 520 may comprise any type of computer storage, such as a hard drive, memory card, ROM, RAM, DVD, CD-ROM, write-capable, and read-only memories. In addition, storage system 520 may include a distributed storage system where data is stored on a plurality of different storage devices, which may be physically located at the same or different geographic locations (e.g., in a distributed computing system such as system 550 in FIG. 5B). Storage system 520 may be networked to computing device 501 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 501, which in some examples may be included in a mobile device and in other examples may be included in a server, also may include a memory 502. Memory 502 may comprise a storage system configured to store a database 514 and an application 516. Application 516 may include instructions which, when executed by a processor 504, cause computing device 501 to perform various steps and/or functions (e.g., performing encodings of video inputs and/or frames of video inputs, extracting features, generating spatial complexity values and temporal complexity values), as described herein. Application 516 further includes instructions for generating a user interface 518 (e.g., graphical user interface (GUI)). Database 514 may store various algorithms and/or data, including neural networks (e.g., convolutional neural networks and other deep neural networks) and data regarding resolutions, bitrates, videos/video renditions, complexity curves and values, device characteristics, network performance, among other types of data. Memory 502 may include any non-transitory computer-readable storage medium for storing data and/or software that is executable by processor 504, and/or any other medium which may be used to store information that may be accessed by processor 504 to control the operation of computing device 501.

Computing device 501 may further include a display 506, a network interface 508, an input device 510, and/or an output module 512. Display 506 may be any display device by means of which computing device 501 may output and/or display data. Network interface 508 may be configured to connect to a network using any of the wired and wireless short range communication protocols described above, as well as a cellular data network, a satellite network, free space optical network and/or the Internet. Input device 510 may be a mouse, keyboard, touch screen, voice interface, and/or any or other hand-held controller or device or interface by means of which a user may interact with computing device 501. Output module 512 may be a bus, port, and/or other interfaces by means of which computing device 501 may connect to and/or output data to other devices and/or peripherals.

In one embodiment, computing device 501 may be a data center or other control facility (e.g., configured to run a distributed computing system as described herein), and may communicate with a server and/or media playback device. As described herein, system 500, and particularly computing device 501, may be used for video playback, running an application, implementing a neural network, communicating with a server and/or a client, and otherwise implementing steps in a implementing a hybrid three pass encoding for video streaming, as described herein. Various configurations of system 500 are envisioned, and various steps and/or functions of the processes described below may be shared among the various devices of system 500 or may be assigned to specific devices

FIG. 5B is a simplified block diagram of an exemplary distributed computing system implemented by a plurality of the computing devices in FIG. 5A, in accordance with one or more embodiments. System 550 may comprise two or more computing devices 501a-n. In some examples, each of 501a-n may comprise one or more of processors 504a-n, respectively, and one or more of memory 502a-n, respectively. Processors 504a-n may function similarly to processor 504 in FIG. 5A, as described above. Memory 502a-n may function similarly to memory 502 in FIG. 5A, as described above.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation. As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A method for deep video complexity analysis comprising:
receiving, by a spatial complexity predictor, a series of frames of a video input;
generating, by the spatial complexity predictor, a spatial complexity label for a frame of the series of frames, the spatial complexity label being based on a DCT-based energy function;
generating, by a temporal complexity predictor, a temporal complexity label for the frame by encoding the frame with respect to a previous frame, the temporal complexity label being based on a comparison of DCT-based energy functions using Sum of Absolute Differences (SAD); and
predicting one or both of an encoding bitrate and an encoding time of the video input may be predicted using the spatial complexity label and the temporal complexity label,
wherein the spatial complexity predictor comprises a deep neural network (DNN), and
the temporal complexity predictor comprises a subset of the building blocks of the spatial complexity predictor.

2. The method of claim 1, wherein generating the spatial complexity label comprises compressing the frame in an all-intra encoding mode.

3. The method of claim 1, wherein the DCT-based energy function maps the texture from a multi-dimensional frequency space into a one-dimensional energy space.

4. The method of claim 1, wherein generating the spatial complexity label comprises encoding the frame as an I-frame.

5. The method of claim 1, wherein the previous frame has been encoded as an I-frame.

6. The method of claim 1, wherein the temporal complexity label is further based on a concatenation of a first feature extracted from a middle building block of the spatial complexity predictor for the frame and a second feature extracted from the middle building block of the spatial complexity predictor for the previous frame.

7. The method of claim 1, wherein the temporal complexity label is based on an SAD of weighted DCT values with respect to the previous frame.

8. The method of claim 1, wherein generating the temporal complexity label comprises encoding the frame as a P-frame.

9. The method of claim 1, wherein generating the temporal complexity label comprises encoding the frame as a B-frame.

10. The method of claim 1, wherein the temporal complexity label comprises a number of bits required to encode a frame in inter-mode.

11. A system for deep video complexity analysis comprising:
a memory comprising non-transitory computer-readable storage medium configured to store video data and neural networks;
one or more processors configured to execute instructions stored on the non-transitory computer-readable storage medium to implement:
a plurality of spatial complexity predictors, each spatial complexity predictor comprising a deep neural network (DNN) having a first convolutional layer, a last convolutional layer, and a plurality of middle building blocks in between the first convolutional layer and the last convolutional layer, a spatial complexity predictor being configured to generate a spatial complexity value for a given frame; and
a plurality of temporal complexity predictors, each temporal complexity predictor comprising a lightweight DNN having a subset of the plurality of middle building blocks and the last convolutional layer, a temporal complexity predictor being configured to generate a temporal complexity value for the given frame using a first extracted feature from one of the plurality of middle building blocks from a first spatial complexity predictor for the given frame and a second extracted feature from the same one of the plurality of building blocks from a second spatial complexity predictor for a frame previous to the given frame, the subset of the plurality of middle building blocks comprising at least a middle building block subsequent to the one of the plurality of middle building blocks.

12. The system of claim 10, wherein each spatial complexity predictor comprises one, or a combination, of a convolutional layer, a fully connected layer, a rectified linear units (ReLU), a building block with residual connections, a batch normalization, a global average pooling layer, an MBConv layer, a depthwise convolutional layer, a Squeeze and Excitation block, and a dropout layer.

13. The system of claim 10, wherein the first convolutional layer, the last convolutional layer, and the plurality of middle building blocks vary in one, or a combination, of a channel size, striding, and a convolutional filter size.

14. The system of claim 10, wherein the one or more processors is further configured to execute instructions stored on the non-transitory computer-readable storage medium to concatenate the first feature extracted and the second extracted feature for inputting to each temporal complexity predictor.

15. The system of claim 10, wherein the one or more processors is further configured to execute instructions stored on the non-transitory computer-readable storage medium to predict one or both of an encoding bitrate and an encoding time of a video input comprising the given frame and the frame previous to the given frame.
